(19) United States
(12) Patent Application Publication
(10) Pub. No.: US 2019/0250645 A1
(43) Pub. Date: Aug. 15, 2019

(54) MOTOR-OPERATED VALVE

(71) Applicant: PACIFIC INDUSTRIAL CO., LTD., Ogaki-shi (JP)

(72) Inventors: Kazuhiro KANAMORI, Ogaki-shi (JP); Terumasa MITSU, Motosu-shi (JP); Takayuki SAKAI, Kakamigahara-shi (JP)

(73) Assignee: PACIFIC INDUSTRIAL CO., LTD., Ogaki-shi (JP)

(21) Appl. No.: 16/202,587

(22) Filed: Nov. 28, 2018

(30) Foreign Application Priority Data
Feb. 13, 2018 (JP) 2018-023033

(51) Int. Cl. G05D 7/06

(52) U.S. Cl. CPC G05D 7/0629; G05D 7/0647

(57) ABSTRACT

An object is to provide a more compact motor-operated valve than conventional ones. The motor-operated valve according to the present disclosure includes a first housing chamber housing a first valve body, a second housing chamber housing a second valve body, and an intermediate chamber interposed therebetween, which are arranged in a line. A shaft is placed to connect the first valve body and the second valve body. The first valve body is fitted into a first fitting portion in the first housing chamber so as to be linearly movable. The second valve body is fitted into a second fitting portion in the second housing chamber so as to be linearly movable. An inside of the first fitting portion and an inside of the second fitting portion communicate with an inside of the intermediate chamber through an air passage provided in the shaft.

### BACKGROUND OF THE INVENTION

### (1) Field of the Invention

The present disclosure relates to a motor-operated valve in which one drive source linearly drives two valve bodies to open and close two valve ports.

### (2) Description of Related Art

Conventionally, as a motor-operated valve of this type, one is known in which a first housing chamber housing a first valve body, a second housing chamber housing a second valve body, and an intermediate chamber interposed therebetween are arranged in a line; the first valve port between the first housing chamber and the intermediate chamber is opened and closed by the first valve body; and the second valve port between the second housing chamber and the intermediate chamber is opened and closed by the second valve body (for example, see FIGS. 9A and 9B of Japanese Patent Application Publication No.: JP 2016-089931 A).

### SUMMARY OF THE INVENTION

However, with the above-described conventional motor-operated valve, the force pushing the valve body caused by the fluid pressure is more largely affected by the differential pressure of the fluid pressure received from the valve port side and the side opposite thereto. In order to cope with this, the drive source must be enlarged in the conventional motor-operated valve, and thus the motor-operated valve has become larger. For this reason, development of a motor-operated valve more compact than conventional ones is required.

The motor-operated valve according to the present disclosure is a motor-operated valve including: a base including a first housing chamber housing a first valve body, a second housing chamber housing a second valve body, and an intermediate chamber, the first housing chamber, the second housing chamber, and the intermediate chamber being arranged in a line such that the intermediate chamber is interposed between the first housing chamber and the second housing chamber; a first valve port that is formed between the first housing chamber and the intermediate chamber and is opened and closed by the first valve body; a second valve port that is formed between the second housing chamber and the intermediate chamber and is opened and closed by the second valve body; a first port communicating with the first housing chamber; a second port communicating with the second housing chamber; a third port communicating with the intermediate chamber; a compound valve body formed by connecting the first valve body and the second valve body with a shaft; a drive source that is connected to an end of the compound valve body to linearly drive and move the compound valve body to a plurality of positions including a first open position where the first valve port is opened and the second valve port is closed and a second open position where the first valve port is closed and the second valve port is opened; a first fitting portion that is provided in the first housing chamber and in which the first valve body is fitted so as to be linearly movable; a second fitting portion that is provided in the second housing chamber and in which the second valve body is fitted so as to be linearly movable; and an air passage that is formed in the shaft and through which an inside of the first fitting portion, an inside of the second fitting portion, and an inside of the intermediate chamber communicate with one another.

The motor-operated valve according to the present disclosure is a motor-operated valve including: a base including a first housing chamber housing a first valve body, a second housing chamber housing a second valve body, and an intermediate chamber, the first housing chamber, the second housing chamber, and the intermediate chamber being arranged in a line such that the intermediate chamber is interposed between the first housing chamber and the second housing chamber; a first valve port that is formed between the first housing chamber and the intermediate chamber and is opened and closed by the first valve body; a second valve port that is formed between the second housing chamber and the intermediate chamber and is opened and closed by the second valve body; a first port communicating with the first housing chamber; a second port communicating with the second housing chamber; a third port communicating with the intermediate chamber; a first spring urging the first valve body to a closed position where the first valve port is closed; a second spring urging the second valve body to a closed position where the second valve port is closed; a shaft passing through the first valve body and the second valve body so as to be linearly movable; a contact portion fixed or integrally formed on a portion of the shaft between the first valve body and the second valve body; a drive source that is connected to an end of the shaft to linearly drive and move the shaft to a plurality of positions including a first open position where the contact portion presses the first valve body to open the first valve port and a second open position where the contact portion presses the second valve body to open the second valve port; a first fitting portion that is provided in the first housing chamber and in which the first valve body is fitted so as to be linearly movable; a second fitting portion that is provided in the second housing chamber and in which the second valve body is fitted so as to be linearly movable; and an air passage that is formed in the shaft and through which an inside of the first fitting portion, an inside of the second fitting portion, and an inside of the intermediate chamber communicate with one another.

### BRIEF DESCRIPTION OF THE DRAWINGS

FIG. 1 is a side cross-sectional view of a motor-operated valve according to a first embodiment;

FIG. 2 is an enlarged side cross-sectional view of a first valve body and a first housing chamber;

FIG. 3 is an enlarged side cross-sectional view of a second valve body and a second housing chamber;

FIG. 4 is a side cross-sectional view of the motor-operated valve of a first mode;

FIG. 5 is a side cross-sectional view of the motor-operated valve of a second mode;

FIG. 6 is a side cross-sectional view of the motor-operated valve of a third mode;

FIG. 7 is a side cross-sectional view of a motor-operated valve according to a second embodiment;

FIG. 8 is a side cross-sectional view of the motor-operated valve of a first mode;

FIG. 9 is a side cross-sectional view of the motor-operated valve of a second mode;

FIG. 10 is a perspective view of a shaft according to a modification;

FIG. 11 is a perspective view of a shaft according to another modification; and

FIG. 12 is a side cross-sectional view of a motor-operated valve according to still another modification.

### DETAILED DESCRIPTION OF PREFERRED EMBODIMENTS

### First Embodiment

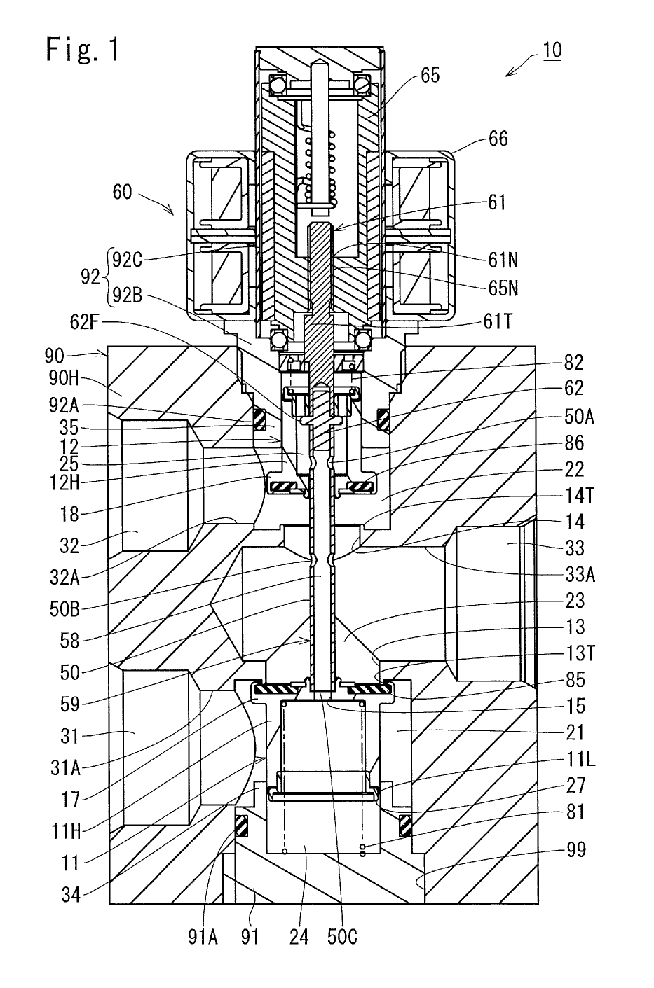

Hereinafter, a motor-operated valve 10 according to the first embodiment will be described with reference to FIGS. 1 to 6. As shown in FIG. 1, a base 90 of the motor-operated valve 10 according to the present embodiment is formed by assembling a plug 91 and a stator body 92 in a center hole 99 passing through a base body 90H in the vertical direction, for example.

The plug 91 has a cylindrical structure with its upper end opened and lower end closed, and is fitted and fixed to the lower end of the center hole 99. An O-ring 91A is provided between the outer circumferential surface of the plug 91 and the inner circumferential surface of the center hole 99, so that the lower end of the center hole 99 is hermetically sealed.

The stator body 92 is formed by attaching a sleeve 92C having a closed upper end to the upper end of a cylindrical stator base 92B having opened upper and lower ends by brazing. Then, the whole stator base 92B excluding part thereof is fitted and fixed into the upper end of the center hole 99, and the sleeve 92C protrudes upward than the base body 90H. An O-ring 92A is also provided between the outer circumferential surface of the stator base 92B and the inner circumferential surface of the center hole 99, so that the upper end of the center hole 99 is hermetically sealed.

An intermediate chamber 23 is formed between a middle lower position apart downward from the middle of the center hole 99 in the longitudinal direction and a middle upper position apart upward from the middle in the longitudinal direction. A first housing chamber 21 is formed below the intermediate chamber 23, and a second housing chamber 22 is formed above the intermediate chamber 23. In addition, the inner diameter of the portion of the center hole 99 constituting the second housing chamber 22 is larger than the inner diameter of the portion constituting the intermediate chamber 23, and the inner diameter of the portion constituting the first housing chamber 21 is larger than the inner diameter of the portion constituting the second housing chamber 22.

A lateral hole 31A extending horizontally from the left side surface of the base 90 in FIG. 1 communicates with the first housing chamber 21, and the opening side end of the lateral hole 31A serves as a first port 31. In addition, a lateral hole 32A extending horizontally from the left side surface of the base 90 in FIG. 1 communicates with the second housing chamber 22, and the opening side end of the lateral hole 32A serves as a second port 32. Further, a lateral hole 33A extending horizontally from the right side surface of the base 90 in FIG. 1 communicates with the intermediate chamber 23, and an opening side end of the lateral hole 33A serves as a third port 33.

All the first port 31 to the third port 33 are enlarged in a stepped manner with respect to the lateral holes 31A, 32A and 33A in whole, respectively, and threads are formed on the inner circumferential surfaces. Then, pipe joints (not shown) are attached to the first port 31 to the third port 33. In addition, the inner diameter of the lateral hole 33A at a portion crossing the center hole 99 is larger than the inner diameter of the center hole 99, and the lateral hole 33A crosses the center hole 99 in a cross shape.

The lower end of the intermediate chamber 23 serves as a first valve port 13 and opens to the inner surface of the first housing chamber 21. A cylindrical valve seat 13T protrudes from the opening edge of the first valve port 13 on the inner surface of the first housing chamber 21. The upper end of the intermediate chamber 23 serves as a second valve port 14 and opens to the inner surface of the second housing chamber 22. Then, a cylindrical valve seat 14T protrudes from the opening edge of the second valve port 14 on the inner surface of the second housing chamber 22.

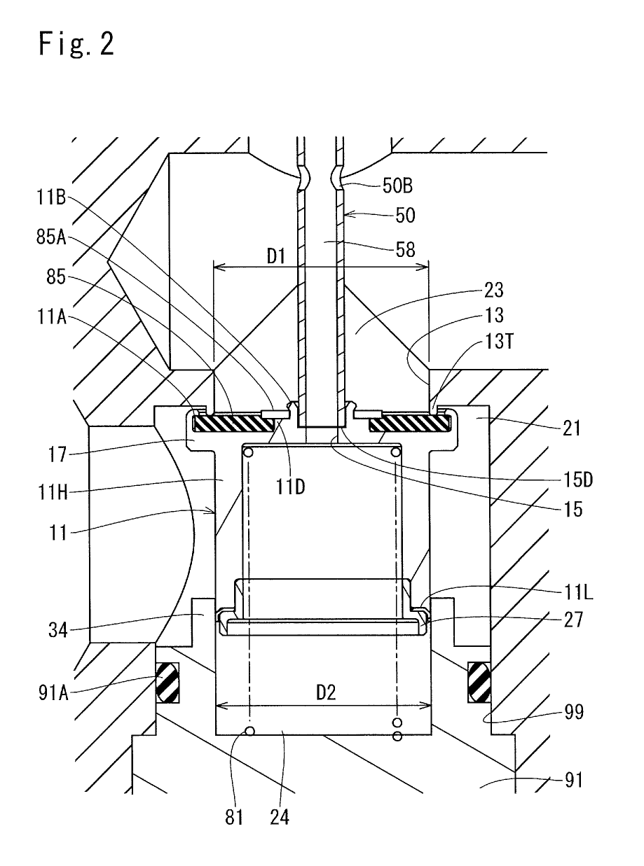

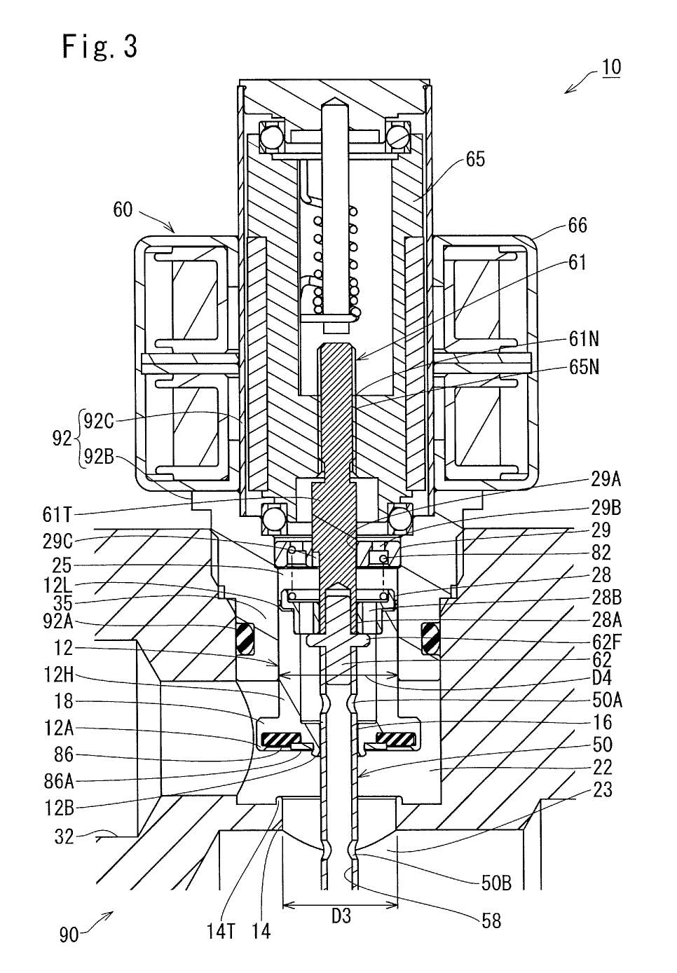

As shown in FIG. 2, a first fitting portion 34 formed of a cylindrical portion of the plug 91 is provided in the first housing chamber 21, and the inner diameter D2 of the first fitting portion 34 and the inner diameter D1 of the first valve port 13 are the same. Similarly, as shown in FIG. 3, a second fitting portion 35 formed of a cylindrical portion of the stator base 92B is provided in the second housing chamber 22, and the inner diameter D4 of the second fitting portion 35 and the inner diameter D3 of the second valve port 14 are the same. The inner diameter D3 of the second valve port 14 is smaller than the inner diameter D1 of the first valve port 13.

As shown in FIG. 2, a first valve body 11 is fitted in the first fitting portion 34 so as to be linearly movable. The first valve body 11 has a cylindrical valve body main body 11H whose upper end is closed by an end wall 17 and whose lower end is opened. An annular seal retainer 27 is fitted to the lower end of the valve body main body 11H. An annular sealing member 11L is sandwiched between the valve body main body 11H and the seal retainer 27, and the annular sealing member 11L is in sliding contact with the inner circumferential surface of the first fitting portion 34. Further, even when having moved to the closed position where the first valve body 11 comes into contact with the valve seat 13T, the first valve body 11 does not come out of the first fitting portion 34. In addition, a first spring 81 that is a compression coil spring is housed in the first valve body 11 to urge the first valve body 11 toward the closed position.

The end wall 17 has a disk shape with a diameter larger than that of the first valve port 13 and protrudes laterally from the entire first valve body 11. A central hole 15 passes through the center portion of the end wall 17. The diameter of the central hole 15 reduces from the upper side to the lower side in a stepped manner and has a stepped surface 15D on the way. A small cylindrical wall 11B protruding from the opening edge of the central hole 15 and a large cylindrical wall 11A protruding from the outer edge are provided on the upper surface of the end wall 17. A seating portion 11D that is raised in a stepped manner is provided on the small cylindrical wall 11B side in an area between the large cylindrical wall 11A and the small cylindrical wall 11B. A disk-shaped packing 85 made of elastomer is laid between the seating portion 11D and the large cylindrical wall 11A, and a disk-shaped holding plate 85A is laid on the seating portion 11D. Then, the large cylindrical wall 11A is swaged, so that the outer edge of the packing 85 is pressed. Also, the small cylindrical wall 11B is swaged, so that the inner edge of the packing 85 is pressed via the holding plate 85A. When the first valve body 11 moves to the closed position, the valve seat 13T comes into contact with the packing 85.

As shown in FIG. 3, a second valve body 12 is fitted in the second fitting portion 35 so as to be linearly movable. The second valve body 12 has a cylindrical valve body main body 12H whose lower end is closed by an end wall 18 and whose upper end is opened contrary to the first valve body 11, and a seal retainer 28 is fitted on the upper end. Then, an annular sealing member 12L is sandwiched between the valve body main body 12H and the seal retainer 28, and the annular sealing member 12L is in sliding contact with the inner circumferential surface of the second fitting portion 35. Further, even when having moved to the closed position where the second valve body 12 comes into contact with the valve seat 14T, the second valve body 12 also does not come out of the second fitting portion 35.

The end wall 18 has a disk shape having a diameter larger than that of the second valve port 14 and protrudes laterally from the entire second valve body 12. Similarly to the aforementioned end wall 17, the end wall 18 is also provided with a large cylindrical wall 12A, a small cylindrical wall 12B, and a holding plate 86A to hold the packing 86. The valve seat 14T comes into contact with the packing 86 when the second valve body 12 moves to the closed position.

A central hole 16 having no stepped surface passes through the center portion of the end wall 18, unlike the aforementioned central hole 15. Further, unlike the seal retainer 27 of the first valve body 11, the seal retainer 28 closes the end opening of the second valve body 12. A central hole 28A is formed also in the center portion of the seal retainer 28, and a plurality of through holes 28B are formed around the central hole 28A.

A partition plate 29 is fitted and fixed at a position close to the upper end of the second fitting portion 35. A second spring 82 that is a compression coil spring is housed between the partition plate 29 and the seal retainer 28 to urge the second valve body 12 toward the closed position. Similarly to the seal retainer 28, a central hole 29A and a plurality of through holes 29B are formed also in the partition plate 29. A groove 29C is formed at one position on the inner circumferential surface of the central hole 29A.

As described above, the stator body 92 constitutes part of the base 90 and also constitutes part of a drive source 60. The drive source 60 is a stepping motor, and includes a rotor 65 in the sleeve 92C of the stator body 92 and an annular armature 66 outside the sleeve 92C. Then, the energization state of the armature 66 is controlled, and the rotor 65 is controlled at any desired rotational position. A threaded hole 65N is formed at the center of the lower end of the rotor 65, and a threaded portion 61N provided at the upper portion of an output shaft 61 is screwed therein. Further, a protrusion 61T protruding from the outer circumferential surface and extending in the vertical direction is provided at a middle portion in the longitudinal direction of the output shaft 61. The output shaft 61 passes through the central hole 29A of the partition plate 29 and the protrusion 61T engages with the groove 29C of the central hole 29A. Due to this, as the rotor 65 rotates, the output shaft 61 linearly moves up and down.

The lower end of the output shaft 61 is fitted in the central hole 28A of the seal retainer 28. Further, the lower end of the output shaft 61 has a cylindrical shape, and the upper portion of a joint bar 62 is pressed therein. A flange 62F protrudes from a middle part in the longitudinal direction of the joint bar 62 and is in contact with the seal retainer 28 of the second valve body 12 from below.

As shown in FIG. 1, the first valve body 11 and the second valve body 12 are connected to each other by a shaft 50 to form a compound valve body 59. As shown in FIG. 2, the shaft 50 has a pipe structure, and the lower end thereof is fitted in the central hole 15 of the first valve body 11 and fixed in a contacting state with the stepped surface 15D. As shown in FIG. 3, the upper end of the shaft 50 is fixed in a state of passing through the central hole 16 of the second valve body 12. The joint bar 62 is pressed into the upper end of the shaft 50 in the second valve body 12 and the upper end is brought into contact with the flange 62F. As a result, the compound valve body 59 is linearly driven up and down by the drive source 60. The shaft 50, the first valve body 11, and the second valve body 12 are fixed by press fitting or adhesive.

An opening 50A is formed at an upper end of the shaft 50 positioned in the second valve body 12, and an opening 50B is formed in a middle part between the first valve body 11 and the second valve body 12. The openings 50A and 50B pass through the shaft 50 from the side and communicate with an air passage 58 in the shaft 50. As shown in FIG. 1, an opening 50C at the lower end of the shaft 50 communicates with the inside of the first valve body 11 through the central hole 15. Thus, a first rear chamber 24 surrounded by the first valve body 11 and the first fitting portion 34, and a second rear chamber 25 surrounded by the second valve body 12 and the second fitting portion 35 have the same internal pressure as that in the intermediate chamber 23.

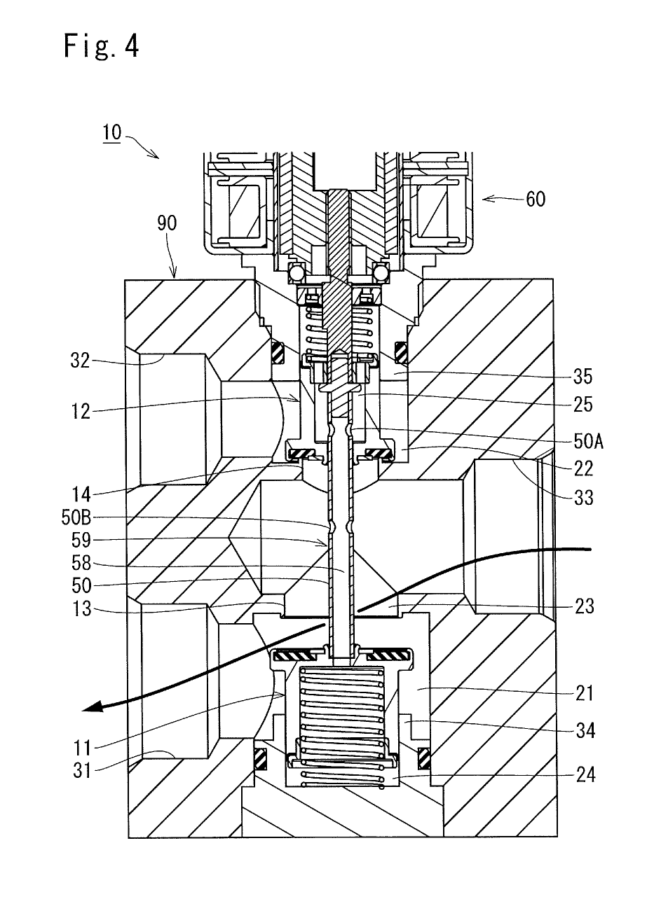

The configuration of the motor-operated valve 10 of the present embodiment has been described above. Next, operational effects of the motor-operated valve 10 will be described. In the motor-operated valve 10 of the present embodiment, the compound valve body 59 formed by connecting the first valve body 11 and the second valve body 12 with the shaft 50 is linearly driven by the drive source 60. When the compound valve body 59 is arranged at the first open position shown in FIG. 4, the first valve port 13 is opened, and the second valve port 14 is closed. As a result, a first mode is established in which only the first port 31 and the third port 33 are connected, among the first port 31 to the third port 33.

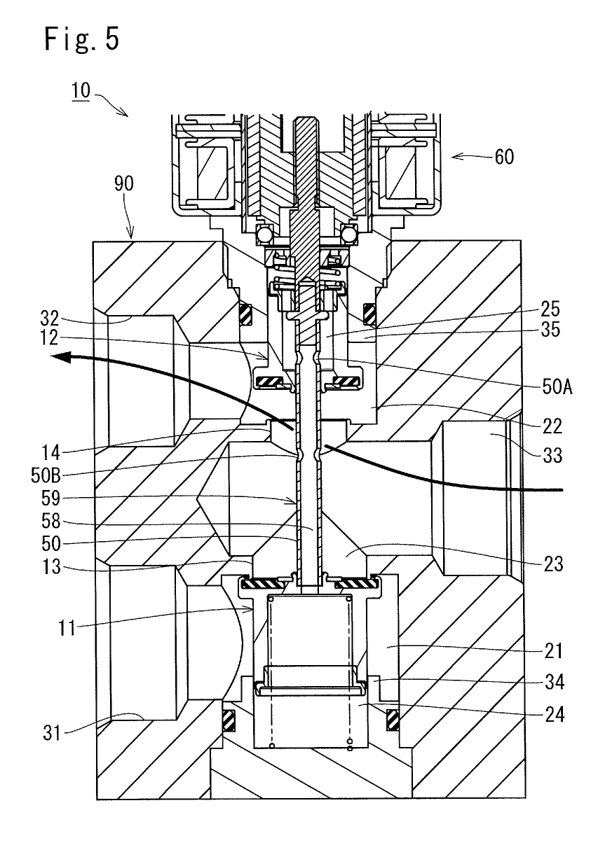

When the compound valve body 59 is arranged at the second open position shown in FIG. 5, the first valve port 13 is closed and the second valve port 14 is opened. As a result, a second mode is established in which only the second port 32 and the third port 33 are connected, among the first port 31 to the third port 33.

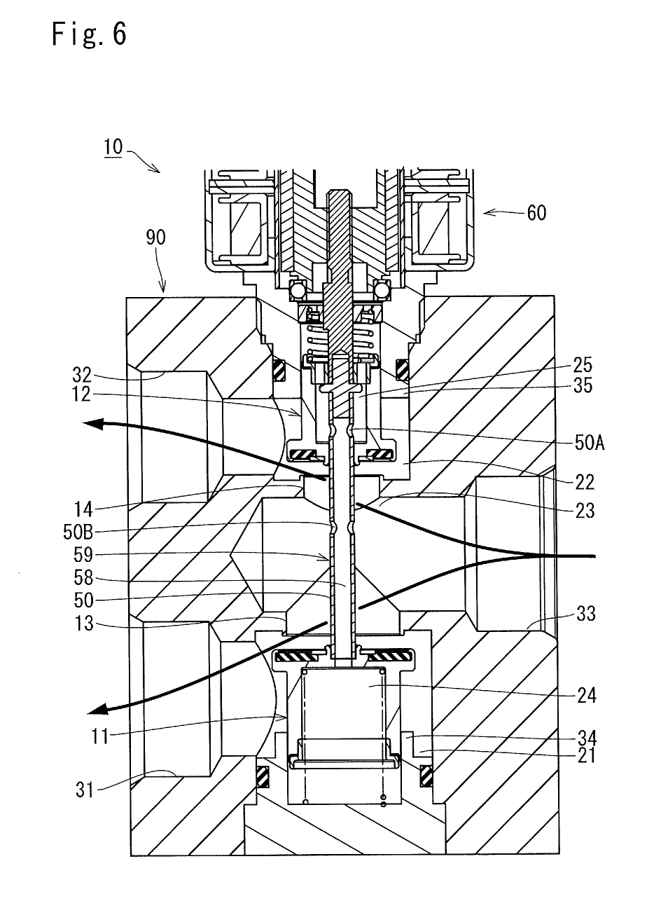

Further, when the compound valve body 59 is arranged at the intermediate open position shown in FIG. 6, both the first valve port 13 and the second valve port 14 are opened. Thus, a third mode is established in which the first port 31 and the second port 32 are connected to the third port 33.

Whether to maintain the third mode can be freely determined by control of the drive source 60. In FIGS. 4 to 6, although the flow of fluid is indicated by arrows when the third port 33 is used as an input port and the first port 31 and the second port 32 are used as output ports, the third port 33 may be used as an output port, and the first port 31 and the second port 32 may be used as input ports. That is, any of the first port 31 to the third port 33 may be used as an input port or an output port.

As described above, according to the motor-operated valve 10 of the present embodiment, the first port 31 to the third port 33 can be connected/disconnected in three types of combination patterns (i.e., three modes). Further, since the area of opening space of the first valve port 13 differs from that of the second valve port 14, a small flow rate change due to opening and closing of the second valve port 14 having a small opening area, and a large flow rate change due to opening and closing of the first valve port 13 having a large opening area are possible.

Here, the first valve body 11 is fitted in the first fitting portion 34 in the first housing chamber 21 so as to be linearly movable, and the second valve body 12 is fitted in the second fitting portion 35 in the second housing chamber 22 so as to be linearly movable, and the inside of the first fitting portion 34 and the inside of the second fitting portion 35 communicate with the inside of the intermediate chamber 23 through the air passage 58 provided in the shaft 50. Due to this, the first valve body 11 and the second valve body 12 are maintained in a state in which the same fluid pressure is applied from each side of the valve ports 13 and 14 and the side opposite thereto, and thus the load applied to the first valve body 11 and the second valve body 12 in the linear motion direction by the fluid pressure is suppressed. As a result, the size of the drive source 60 can be reduced, so that the motor-operated valve 10 can be made compact, and power consumption can also be suppressed.

Moreover, the inner diameter D1 of the first valve port 13 and the inner diameter D2 of the first fitting portion 34 in which the first valve body 11 is fitted are the same as shown in FIG. 2, and the inner diameter D3 of the second valve port 14 and the inner diameter D4 of the second fitting portion 35 in which the second valve body 12 is fitted are the same as shown in FIG. 3. Therefore, the load that the first valve body 11 and the second valve body 12 receive in the linear motion direction by fluid pressure (excluding the dynamic pressure) can be brought close to “0”, so that the valve can be used also under a situation where the fluid pressure is high.

Further, since the air passage 58 is formed in the shaft 50, there is no need to secure a space for separately arranging the air passage around the portion in which the shaft 50 is fitted, of the first valve body 11 and the second valve body 12. This enables the packings 85 and 86 to be fixed in the empty spaces of the first valve body 11 and the second valve body 12 where separate arrangement of an air passage is no longer necessary, so as to increase the airtightness at the time of valve closing. In addition, since an end of the shaft 50 is connected to the output shaft 61 of the drive source 60, the structure can be simplified, and the weight of the compound valve body 59 can be reduced.

By forming the air passage 58 in the shaft 50 without providing a separate air passage around the shaft 50 on the first valve body 11 and the second valve body 12, reduction of the size, weight, and manufacturing cost of the first valve body 11 and the second valve body 12 may be attained. Further, although the inner diameter D1 of the first valve port 13 and the inner diameter D2 of the first fitting portion 34 are the same in the above configuration, not all but only part of the load acting on the first valve body 11 in the linear motion direction due to the fluid pressure (excluding the dynamic pressure) may be reduced by differentiating the inner diameters D1 and D2 from each other. The same applies to the inner diameters D3 and D4 of the second valve port 14 and the second fitting portion 35. Furthermore, in the above configuration, the first spring 81 and the second spring 82 are provided to assist the drive source 60, but one or both of these may be eliminated. Further, although, in the present embodiment, the shaft 50 is fixed to the first valve body 11 by adhesive or press fitting, a configuration may be adopted in which the first valve body 11 and the shaft 50 are kept connected by the resilient force of the first spring 81 and the first valve body 11, and the shaft 50 may be separated when there is no resilient force of the first spring 81.

### Second Embodiment

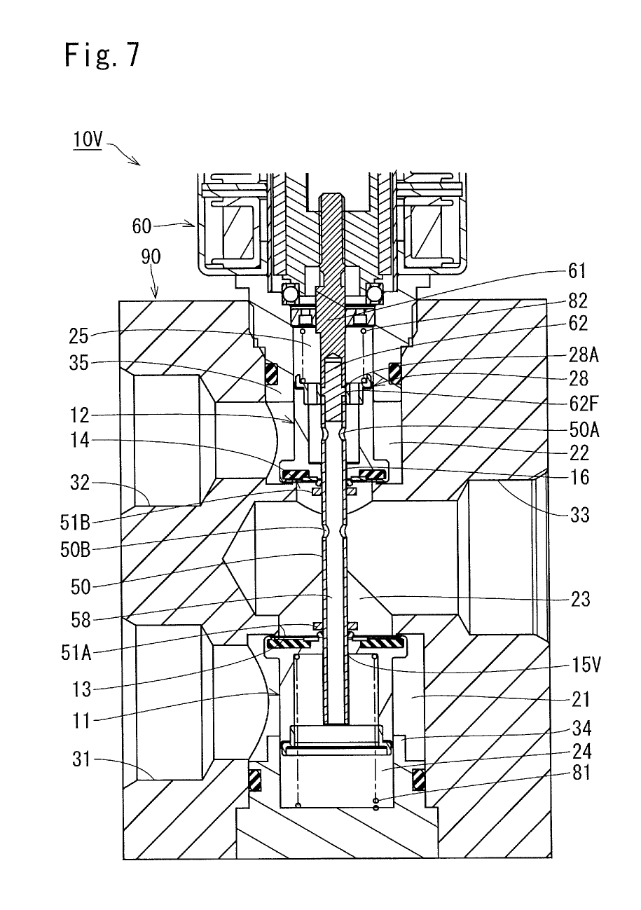

A motor-operated valve 10V of the present embodiment is shown in FIGS. 7 to 9 and is different from the first embodiment in that the shaft 50 is linearly movable independently of the first valve body 11 and the second valve body 12. Specifically, in the present embodiment, a central hole 15V of the first valve body 11 described in the first embodiment does not have the stepped surface 15D and has a uniform diameter. Further, the flange 62F of the joint bar 62 has an outer diameter so as not to protrude than the outer circumferential surfaces of the output shaft 61 and the shaft 50. The shaft 50 moves linearly in the central holes 15V and 16 of the first valve body 11 and the second valve body 12 and in the central hole 28A of the seal retainer 28, and the output shaft 61 also moves linearly in the central hole 28A. In addition, a disk-shaped contact portion 51A is fixed at a position close to the first valve body 11, and a disk-shaped contact portion 51B is fixed at a position close to the second valve body 12 on a portion of the shaft 50 sandwiched between the first valve body 11 and the second valve body 12. Since the other configurations are the same as that of the motor-operated valve 10 of the first embodiment, redundant descriptions will be omitted.

In the motor-operated valve 10V of the present embodiment, the shaft 50 is linearly movable independently of the first valve body 11 and the second valve body 12. As shown in FIG. 7, when the shaft 50 is arranged at the intermediate closed position, a state is established in which the first valve body 11 closes the first valve port 13 and the second valve body 12 closes the second valve port 14. At this time, one contact portion 51A is adjacent to the first valve body 11, and the other contact portion 51B is adjacent to the second valve body 12.

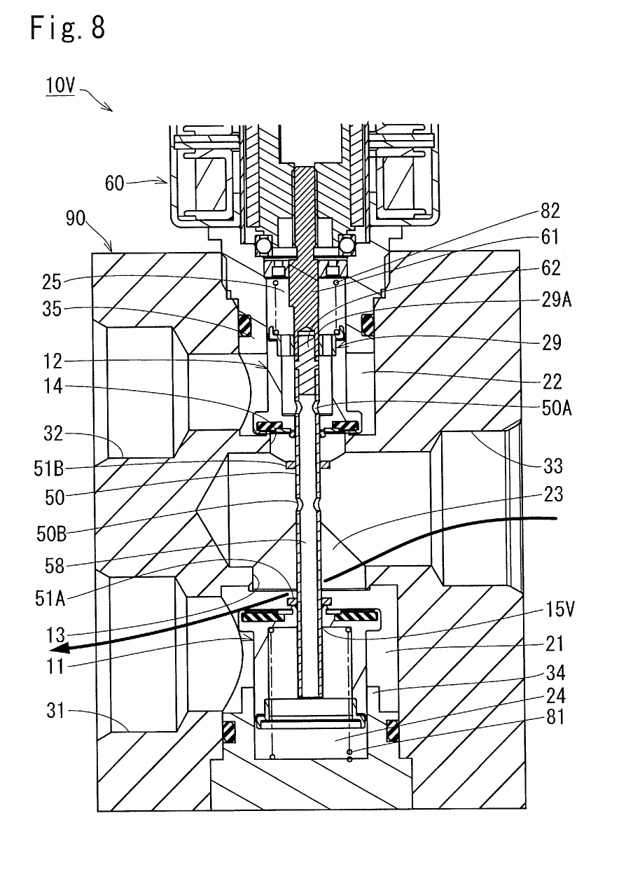

When the shaft 50 moves from the intermediate closed position to the first open position, the first valve body 11 is pushed by the one contact portion 51A to open the first valve port 13, and the other contact portion 51B moves away from the second valve body 12, so that the second valve port 14 is kept closed by the second valve body 12, as shown in FIG. 8.

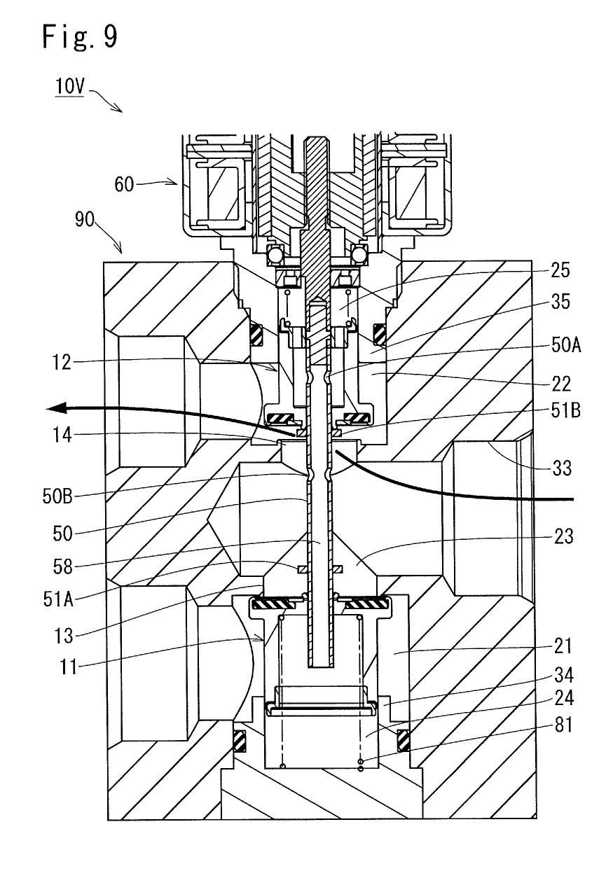

When the shaft 50 moves from the intermediate closed position to the second open position, the second valve body 12 is pushed by the other contact portion 51B to open the second valve port 14, and the one contact portion 51A moves away from the first valve body 11, so that the first valve port 13 is kept closed by the first valve body 11, as shown in FIG. 9.

As described above, also with the motor-operated valve 10V of the present embodiment, the first port 31 to the third port 33 can be connected/disconnected in three types of combination patterns (i.e., three modes). In addition, the same effects as those of the motor-operated valve 10 of the first embodiment are obtained.

### OTHER EMBODIMENTS

In addition to the above-described embodiments, configurations exemplified below are conceivable.

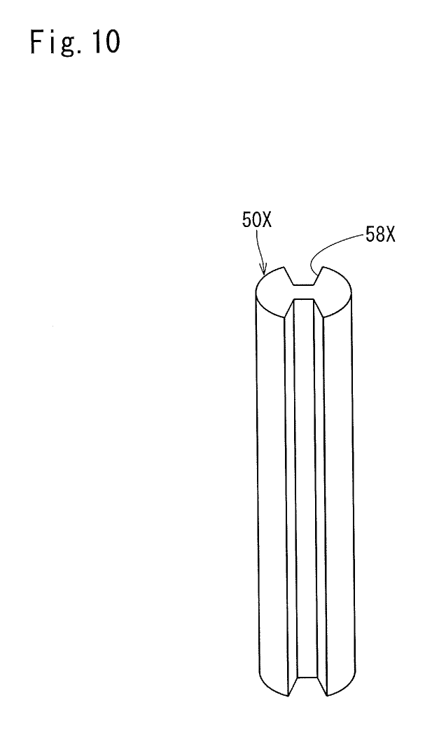

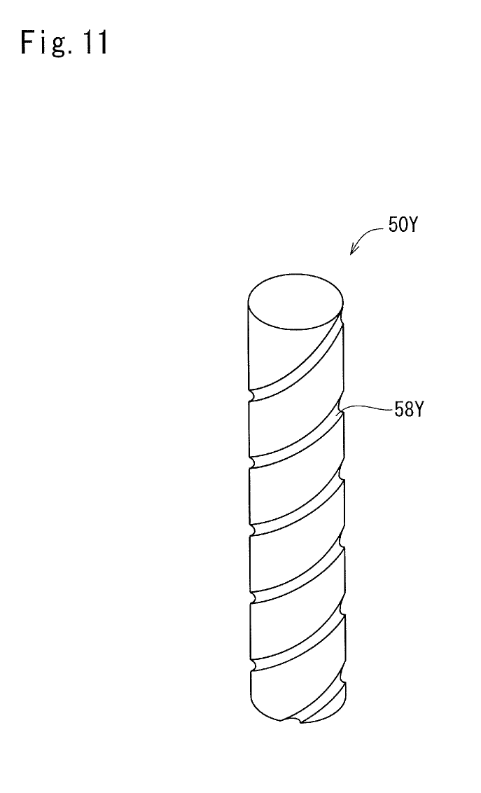

(1) Although the shaft 50 of the first embodiment and the second embodiment has a pipe structure including the air passage 58 therein, a configuration in which a groove-shaped air passage 58X is provided on the outer surface like a shaft 50X shown in FIG. 10, or a spiral-groove-shaped air passage 58Y is provided on the outer surface like a shaft 50Y shown in FIG. 11 may be employed, and the inside of the first fitting portion 34 and the inside of the second fitting portion 35 may be made to communicate with the inside of the intermediate chamber 23 through these air passages 58X and 58Y.

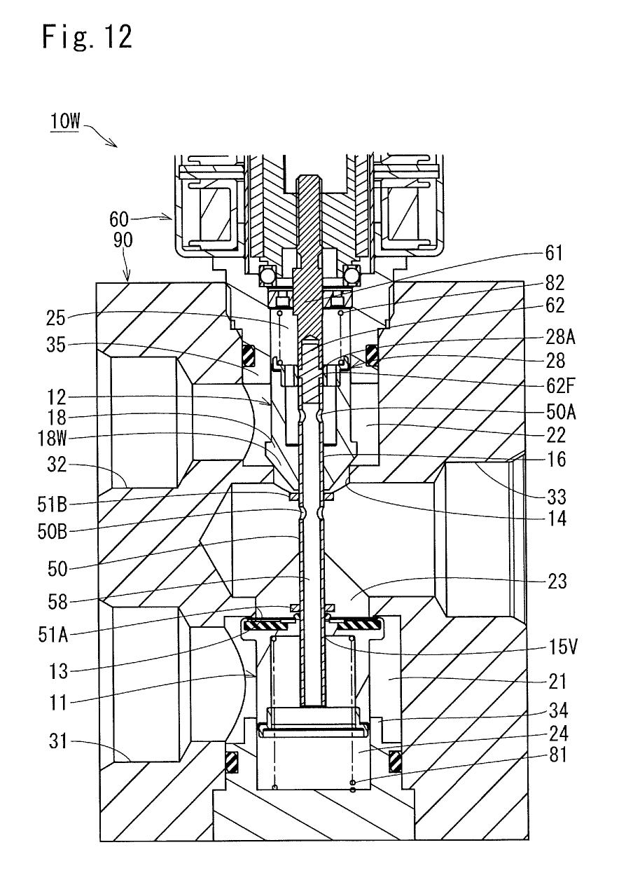

(2) Further, as in a motor-operated valve 10W shown in FIG. 12, the motor-operated valve 10V of the second embodiment is modified to have a tapered portion 18W on the end wall 18 of the second valve body 12, so that flow rate control can be performed by using the second valve port 14. Further, although not illustrated, a tapered portion may be provided also on the end wall 17 of the first valve body 11, so that flow rate control can be performed by both the first valve port 13 and the second valve port 14.

(3) In the first embodiment and the second embodiment, instead of the shaft 50, a shaft formed by extending the output shaft 61 of the drive source 60 so as to pass through the first valve body 11 and the second valve body 12 may be used as the “shaft”.

(4) Although, the inner diameter D3 (see FIG. 3) of the second valve port 14 is smaller than the inner diameter D1 (see FIG. 2) of the first valve port 13 in the first embodiment, the second embodiment and the modification shown in FIG. 12, the inner diameter D3 of the second valve port 14 may be larger than the inner diameter D1 of the first valve port 13, or the inner diameter D1 of the first valve port 13 and the inner diameter D3 of the second valve port 14 may be the same.

What is claimed is:

1. A motor-operated valve comprising:
a base including a first housing chamber housing a first valve body, a second housing chamber housing a second valve body, and an intermediate chamber, the first housing chamber, the second housing chamber, and the intermediate chamber being arranged in a line such that the intermediate chamber is interposed between the first housing chamber and the second housing chamber;
a first valve port that is formed between the first housing chamber and the intermediate chamber and is opened and closed by the first valve body;
a second valve port that is formed between the second housing chamber and the intermediate chamber and is opened and closed by the second valve body;
a first port communicating with the first housing chamber;
a second port communicating with the second housing chamber;
a third port communicating with the intermediate chamber;
a compound valve body formed by connecting the first valve body and the second valve body with a shaft;
a drive source that is connected to an end of the compound valve body to linearly drive and move the compound valve body to a plurality of positions including a first open position where the first valve port is opened and the second valve port is closed and a second open position where the first valve port is closed and the second valve port is opened;
a first fitting portion that is provided in the first housing chamber and in which the first valve body is fitted so as to be linearly movable;
a second fitting portion that is provided in the second housing chamber and in which the second valve body is fitted so as to be linearly movable; and
an air passage that is formed in the shaft and through which an inside of the first fitting portion, an inside of the second fitting portion, and an inside of the intermediate chamber communicate with one another.

2. The motor-operated valve according to claim 1, wherein
the shaft has a pipe structure including the air passage therein and a plurality of openings that are opened toward the inside of the first fitting portion, the inside of the second fitting portion, and the inside of the intermediate chamber.

3. The motor-operated valve according to claim 2, further comprising:
a central hole passing through a center portion of the first valve body; and
a stepped surface that is formed at an intermediate portion of the central hole and with which an end surface of the shaft comes into contact.

4. The motor-operated valve according to claim 1, wherein
central holes through which the shaft passes are formed at center portions of the first valve body and the second valve body and
the air passage is formed into a groove shape in a portion of the shaft where the shaft passes through the central holes.

5. The motor-operated valve according to claim 4, wherein
the air passage has a spiral shape.

6. The motor-operated valve according to claim 1, wherein
the shaft passes through the second valve body, and an end of the shaft is connected to the drive source.

7. The motor-operated valve according to claim 2, wherein
the shaft passes through the second valve body, and an end of the shaft is connected to the drive source.

8. The motor-operated valve according to claim 3, wherein
the shaft passes through the second valve body, and an end of the shaft is connected to the drive source.

9. The motor-operated valve according to claim 4, wherein
the shaft passes through the second valve body, and an end of the shaft is connected to the drive source.

10. The motor-operated valve according to claim 5, wherein
the shaft passes through the second valve body, and an end of the shaft is connected to the drive source.

11. The motor-operated valve according to claim 1, wherein
areas of opening spaces of the first valve port and the second valve port are different from each other.

12. The motor-operated valve according to claim 2, wherein
areas of opening spaces of the first valve port and the second valve port are different from each other.

13. The motor-operated valve according to claim 3, wherein
areas of opening spaces of the first valve port and the second valve port are different from each other.

14. The motor-operated valve according to claim 4, wherein
areas of opening spaces of the first valve port and the second valve port are different from each other.

15. The motor-operated valve according to claim 1, comprising:
a large cylindrical wall and a small cylindrical wall that have concentric cylindrical shapes and protrude from an end surface of the first valve body or the second valve body;
a packing that is arranged between the large cylindrical wall and the small cylindrical wall and is fixed by swaging the large cylindrical wall and the small cylindrical wall; and
an annular protrusion protruding from an opening edge of the first valve port or the second valve port and coming into contact with the packing, wherein
the shaft fits inside the small cylindrical wall.

16. The motor-operated valve according to claim 2, comprising:
a large cylindrical wall and a small cylindrical wall that have concentric cylindrical shapes and protrude from an end surface of the first valve body or the second valve body;
a packing that is arranged between the large cylindrical wall and the small cylindrical wall and is fixed by swaging the large cylindrical wall and the small cylindrical wall; and
an annular protrusion protruding from an opening edge of the first valve port or the second valve port and coming into contact with the packing, wherein
the shaft fits inside the small cylindrical wall.

17. The motor-operated valve according to claim 3, comprising:
a large cylindrical wall and a small cylindrical wall that have concentric cylindrical shapes and protrude from an end surface of the first valve body or the second valve body;
a packing that is arranged between the large cylindrical wall and the small cylindrical wall and is fixed by swaging the large cylindrical wall and the small cylindrical wall; and
an annular protrusion protruding from an opening edge of the first valve port or the second valve port and coming into contact with the packing, wherein
the shaft fits inside the small cylindrical wall.

18. The motor-operated valve according to claim 4, comprising:
a large cylindrical wall and a small cylindrical wall that have concentric cylindrical shapes and protrude from an end surface of the first valve body or the second valve body;
a packing that is arranged between the large cylindrical wall and the small cylindrical wall and is fixed by swaging the large cylindrical wall and the small cylindrical wall; and
an annular protrusion protruding from an opening edge of the first valve port or the second valve port and coming into contact with the packing, wherein
the shaft fits inside the small cylindrical wall.

19. A motor-operated valve comprising:
a base including a first housing chamber housing a first valve body, a second housing chamber housing a second valve body, and an intermediate chamber, the first housing chamber, the second housing chamber, and the intermediate chamber being arranged in a line such that the intermediate chamber is interposed between the first housing chamber and the second housing chamber;
a first valve port that is formed between the first housing chamber and the intermediate chamber and is opened and closed by the first valve body;
a second valve port that is formed between the second housing chamber and the intermediate chamber and is opened and closed by the second valve body;
a first port communicating with the first housing chamber;
a second port communicating with the second housing chamber;
a third port communicating with the intermediate chamber;
a first spring urging the first valve body to a closed position where the first valve port is closed;
a second spring urging the second valve body to a closed position where the second valve port is closed;
a shaft passing through the first valve body and the second valve body so as to be linearly movable;
a contact portion fixed or integrally formed on a portion of the shaft between the first valve body and the second valve body;
a drive source that is connected to an end of the shaft to linearly drive and move the shaft to a plurality of positions including a first open position where the contact portion presses the first valve body to open the first valve port and a second open position where the contact portion presses the second valve body to open the second valve port;
a first fitting portion that is provided in the first housing chamber and in which the first valve body is fitted so as to be linearly movable;
a second fitting portion that is provided in the second housing chamber and in which the second valve body is fitted so as to be linearly movable; and
an air passage that is formed in the shaft and through which an inside of the first fitting portion, an inside of the second fitting portion, and an inside of the intermediate chamber communicate with one another.

20. The motor-operated valve according to claim 19, wherein
at least one of the first valve body and the second valve body has a tapered portion that tapers off toward the first valve port or the second valve port.
